(19) United States
(12) Patent Application Publication
(10) Pub. No.: US 2026/0264148 A1
(43) Pub. Date: Sep. 10, 2026

(54) ADDITIVE MANUFACTURING METHOD FOR CEMENTED CARBIDES

(71) Applicant: CENTRAL SOUTH UNIVERSITY, Changsha (CN)

(72) Inventors: Zuming LIU, Changsha (CN); Cai CHEN, Changsha (CN); Boyun HUANG, Changsha (CN); Yongxia LI, Changsha (CN); Dan ZOU, Changsha (CN); Yiming CHANG, Changsha (CN); Lei CHEN, Changsha (CN); Runxing ZHOU, Changsha (CN); Xulin CHENG, Changsha (CN)

(73) Assignee: CENTRAL SOUTH UNIVERSITY, Changsha (CN)

(21) Appl. No.: 19/661,769

(22) Filed: Apr. 29, 2026

Related U.S. Application Data
(63) Continuation-in-part of application No. PCT/CN2024/122748, filed on Sep. 30, 2024.

(30) Foreign Application Priority Data
Oct. 30, 2023 (CN) 202311420909.8

(51) Int. Cl. B22F 10/322; B22F 1/14; B22F 10/16; B33Y 10/00; B33Y 40/10; B33Y 70/00

(52) U.S. Cl. CPC B22F 10/322; B22F 1/14; B22F 10/16; B22F 2302/10; B33Y 10/00; B33Y 40/10; B33Y 70/00

(57) ABSTRACT

An additive manufacturing (AM) method for cemented carbides includes the specific steps: Preparing a uniformly dispersed cemented carbide powder by ball milling; preparing a printing feedstock by internal mixing; preparing a printed green body by material extrusion using the feedstock; and subjecting the printed green body to debinding-vacuum pressure sintering to obtain a cemented carbide product. A cemented carbide product prepared by combining green body printing with two-step solvent debinding, thermal debinding and vacuum pressure sintering has free of pores, cracks and harmful phases such as decarburization, carbon defects and brittle phases, simple phase composition, high relative density and excellent comprehensive mechanical properties. The method effectively solves the difficult problems of cracking, pores, decarburization, brittle phases, deformation, low relative density, poor comprehensive mechanical properties and the like which make troubles in AM of cemented carbide for a long time and are difficult to solve by a present AM process.

### CROSS REFERENCE TO THE RELATED APPLICATIONS

This application is a continuation-in-part application of International Application No. PCT/CN2024/122748, filed on Sep. 30, 2024, which is based upon and claims priority to Chinese Patent Application No. 202311420909.8, filed on Oct. 30, 2023, the entire contents of which are incorporated herein by reference.

### TECHNICAL FIELD

The present disclosure relates to an additive manufacturing (AM) method for cemented carbides with excellent comprehensive mechanical properties, and in particular, to an AM method for cemented carbides having high hardness, high transverse rupture strength, and high fracture toughness, and belongs to the technical fields of cemented carbides and AM.

### BACKGROUND

A cemented carbide, known as the “teeth of industry”, is a composite materials consisting of a hard-refractory metal compound and a binder metal. It possesses excellent mechanical properties such as high hardness, high wear resistance, high transverse rupture strength, and high elastic modulus, and thus serves as a key material used in the fields such as manufacturing, resource extraction, transportation, electronic information industry, and infrastructure construction. A cemented carbide is traditionally prepared by a powder metallurgical process. However, at present, AM emerges and provides a new technological path for preparing cemented carbide complex geometric structured parts.

Powder bed fusion (PBF), the main method currently used in AM of cemented carbides, includes techniques such as selective laser sintering (SLS), selective laser melting (SLM), and selective electron beam melting (SEBM). PBF can be used for directly preparing cemented carbide complex geometric structured parts. However, PBF requires excellent properties of raw powders, including sphericity, particle size distribution, apparent density, tap density, flowability, and the like. However, the products prepared by PBF suffer from defects such as difficult-to-eliminate pores, cracks, and abnormal grain growth, oxidation and decarburization, formation of brittle phases, low relative density, and poorer mechanical properties. WC-17% Co cemented carbide prepared by Kumar et al. [S Kumar, et al., Optimization of parameters for SLS of WC—Co [J]. Rapid Prototyping Journal, 2017, 23(6): 1202-1211] using SLS exhibits numerous pores and large-sized cracks, no strength data is reported. WC-12Co cemented carbide prepared by Fries et al. [S Fries, et al., Influence of post heat treatment on microstructure and fracture strength of cemented carbides manufactured using laser-based additive manufacturing [J]. International Journal of Refractory Metals and Hard Materials, 111 (2023) 106085] using laser powder bed fusion (LPBF) shows severe cracking, the appearance of a η phase or ternary phase, and lower mechanical properties. WC-12Co cemented carbide prepared by Kim et al. [K W Kim, et al. Microstructural and wear properties of WC-12Co cemented carbide fabricated by direct energy deposition [J]. Wear, 518-519 (2023) 204653] using direct energy deposition (DED) has no transverse rupture strength and fracture toughness reported. WC-12Co cemented carbide prepared by Wang et al. [J Wang, et al. Microstructure and properties of WC-12Co cemented carbide fabricated via selective electron beam melting [J]. International Journal of Refractory Metals and Hard Materials, 106 (2022) 105847] using SEBM exhibits a Co₃W₃C ternary phase, with a transverse rupture strength of 1770 MPa and a transverse rupture strength of 1839 MPa after heat treatment, with no fracture toughness data reported. WC-12Co cemented carbide prepared by Xing et al. [M Xing, et al. Additive manufacturing of cemented carbides inserts with high mechanical performance [J]. Materials Science and Engineering: A, 861 (2022) 144350] using LPBF also exhibits a brittle Co₃W₃C ternary phase, a transverse rupture strength of 998 MPa in as-printed state, and transverse rupture strengths of 3426 MPa and 3802 MPa after heat treatment at 1390° C. and 1480° C., respectively, with no fracture toughness data of the as-printed cemented carbides reported.

Recently, Mariani et al. [M Mariani, et al., Mechanical and microstructural characterization of WC—Co consolidated by binder jetting additive manufacturing [J], International Journal of Refractory Metals & Hard Materials. 100 (2021) 105639] prepared a WC-12% Co cemented carbide with a relative density of 97.4% using binder jetting (BJT)-debinding-vacuum sintering, and obtains a sample with a relative density of 99.3% after hot isostatic pressing (HIP) treatment, with a Vickers hardness and a transverse rupture strength of 1205 HV and 2257 MPa, respectively. WC-12Co cemented prepared by Enneti et al. [R K Enneti, et al., Wear properties of sintered WC-12% Co processed via Binder Jet 3D Printing (BJ3DP) [J], International Journal of Refractory Metals & Hard Materials. 78 (2019) 228-232] using BJ3DP-vacuum sintering has the highest relative density of 94%, and a sintering-HIP sample has a relative density of 99%, with no strength data reported. WC-(10, 12, 17)Co cemented carbide prepared by Wolfe et al. [T A Wolfe, et al. Binder jetting 3D printed cemented carbide: Mechanical and wear properties of medium and coarse grades [J]. International Journal of Refractory Metals and Hard Materials, 113 (2023) 106197] using BJ3DP-sintering-HIP has a Vickers hardness, a transverse rupture strength, and a fracture toughness of 990 HV30 to 1300 HV30, 814 MPa to 2684 MPa, and 17 MN·m^{-3/2} to 23 MN·m^{-3/2}, respectively. WC—Co cemented carbide prepared by Cramer et al. [C L Cramer, et al. Binder jet printed WC infiltrated with pre-made melt of WC and Co [J]. International Journal of Refractory Metals and Hard Materials, 87 (2020) 105137] using BJT AM has a hardness of 8.34 GPa and a fracture toughness of 24.7 MPa·m^{1/2}, with no transverse rupture strength data reported. The indexable insert of WC-10% Co cemented carbide was prepared by Lengauer et al. [W Lengauer, et al., Fabrication and properties of extrusion-based 3D-printed hardmetal and cermet components [J], International Journal of Refractory Metals & Hard Materials. 82 (2019) 141-149.] using an extrusion-based additive manufacturing process, it has a printed green body with dense pores in a construction direction (Z direction), and no relative density and mechanical properties of the sintered sample reported. WC-10Co cemented carbide prepared by Zhao et al. [Z Zhao, et al., Additive manufacturing of cemented carbide using analogous powder injection molding feedstock [J], International Journal of Refractory Metals and Hard Materials. 111 (2023) 106095] using an material extrusion (MEX)-debinding-sintering process has a relative density of 99.3%, as well as a Vickers hardness, a transverse rupture strength, and a fracture toughness of 1350-20 HV30, 1695±30 MPa, and 7.27 MPa·m^{1/2}, respectively. In the above processes, the BJT AM method uses a powder-bed-based powder spreading method similar to that of the PBF, with the same requirements for the properties of raw powders as the PBF, and the cemented carbide part prepared exhibits a simpler shape and a low relative density. The MEX AM process is prone to problems such as large-sized wedge-shaped pore, and interlayer cracks, as well as a lower relative density.

In view of the above problems, the present disclosure provides an AM method for cemented carbides: (1) a uniformly dispersed cemented carbide powder is prepared by ball milling; (2) a printing feedstock with a high powder loading is prepared; (3) a cemented carbide printed green body is prepared using the feedstock, and the printed pore defect in the green body is eliminated; and (4) two-step debinding-vacuum pressure sintering is carried out on the printed green body to obtain a cemented carbide product with excellent comprehensive mechanical properties.

### SUMMARY

The present disclosure provides an AM method for cemented carbides exhibiting excellent comprehensive mechanical properties, including the following steps: (1) preparing a uniformly dispersed cemented carbide powder by ball milling; (2) preparing a printing feedstock with a high powder loading by internal mixing; (3) preparing a cemented carbide printed green body using the feedstock; and (4) subjecting the printed green body to debinding-vacuum pressure sintering to obtain a cemented carbide product exhibiting excellent comprehensive mechanical properties. The pressure is controlled to be greater than or equal to 5 MPa during the pressure sintering.

The present disclosure specifically includes the following steps:
(1) preparing a cemented carbide powder by ball milling:
mixing a hard raw powder WC; or a hard raw powder WC and at least one of TiC, Ti(C, N), (W, Ti)C and (W, Ti, Ta)C; or a hard powder WC and at least one of VC, Cr₃C₂, TaC and (Ta, Nb)C; or a hard powder WC and at least one of TiC, Ti(C, N), (W, Ti)C and (W, Ti, Ta)C, as well as at least one of VC, Cr₃C₂, TaC, and (Ta, Nb)C, with
at least one of binder metal raw powders Co and Ni according to a designed ratio; and
carrying out ball milling to prepare a uniformly dispersed cemented carbide powder;
(2) preparing a printing feedstock by internal mixing:
adding the cemented carbide powder and an organic binder into an internal mixing chamber of an internal mixer according to a designed ratio and mixing the same, to prepare a uniformly mixed mixture of the cemented carbide powder and the organic binder; and
adding the prepared mixed mixture into a granulator and granulating the same to prepare a granular printing feedstock with a particle size of 1 mm to 4 mm;
(3) preparing a printed green body by AM:
using the granular printing feedstock obtained in step (2) as a raw material, preparing a printed cemented carbide green body using a MEX device;
(4) subjecting the cemented carbide printed green body to solvent debinding: firstly, soaking the printed green body in n-heptane for debinding, then soaking the green body in gasoline and/or kerosene for debinding, and finally carrying out vacuum drying to obtain a solvent debound green body, where the soaking debinding time is determined according to the size of the green body, and the debinding temperature and the drying temperature and time are determined according to the characteristic temperatures of the organic binder and solvents;

Where, the characteristic temperatures of the organic binder and the solvents refer to the melting/fusing temperature and the volatilization temperature; and
(5) thermal debinding-sintering: subjecting the solvent debound green body obtained in step (4) to thermal debinding-vacuum pressure sintering to obtain a solid cemented carbide part, where the pressure is controlled to be greater than or equal to 5 MPa during the pressure sintering.

Where, the hard raw material and the binder metal Co and Ni raw powders in step (1) are powders that meet the requirements for commercial powder metallurgical cemented carbides. The ball milling may be carried out using a ball milling process used in a present cemented carbide powder metallurgical technology. In addition to the raw powders, paraffin is further added, with the amount of the paraffin added accounting for 0.5% to 5% of the total mass of all raw powders.

Where, in the printing feedstock in step (2), the volume proportion of the cemented carbide powder is 40% to 70%, and the volume proportion of the organic binder is 60% to 30%. The volume proportion of the cemented carbide powder in the feedstock is defined as a powder loading.

Where, the difficulty in designing the organic binder as described in step (2) lies in that the printing feedstock having a high powder loading also exhibits a shear-thinning characteristic of a pseudoplastic fluid, and good temperature stability, and good thermoplasticity, thereby ensuring that the printing feedstock has a wider printing process window and the printed green body has higher transverse rupture strength to avoid debinding defects such as cracks and swelling. The present disclosure optimizes the composition of the organic binder, and the organic binder includes a framework component, a plasticizing component, and a dispersing component. The framework component is at least one of polyethylene, polypropylene, ethylene-vinyl acetate copolymer, polymethyl methacrylate, polystyrene, polyacetal, and the like. The plasticizing component includes at least one of paraffin, microcrystalline wax, beeswax, carnauba wax, and the like. The dispersing component is at least one of stearic acid and stearate. In the organic binder, the volume proportion of the plasticizing component is 35% to 65%, the volume proportion of the framework component is 30% to 50%, and the volume proportion of the dispersing component is 1% to 15%.

Where, internal mixing parameters in step (2) include an internal mixing temperature of 100° C. to 200° C., a rotation speed of 30 rpm to 100 rpm, and an internal mixing time of 30 min to 300 min.

Preparation parameters of the printing feedstock in step (2) include a rotation speed of a screw rod of 30 rpm to 100 rpm, a pressure of the screw rod of 3 kg to 10 kg, and a diameter of prepared printing feedstock particles of 1 mm to 4 mm.

The amount of the paraffin used in step (2) includes the amount of the paraffin added in the ball milling process in step (1), namely the amount of the paraffin used in the organic binder in step (2) is the sum of the amount of the paraffin used in the ball milling process in step (1) and the amount of the paraffin added later.

Preferably, the organic binder contains stearic acid, polyethylene, polypropylene and paraffin in a volume ratio of (7-12):(18-22):(18-22):(40-55).

More preferably, the organic binder contains stearic acid, polyethylene, polypropylene and paraffin in a volume ratio of (8-12):(18-22):(18-22):(45-55).

Preferably, the organic binder contains stearic acid, polyethylene, polypropylene, polymethyl methacrylate, polystyrene and paraffin in a volume ratio of (7-12):(7-12):(7-12):(6-12):(6-12):(40-55).

As a further preferred embodiment, the organic binder contains stearic acid, polyethylene, polypropylene, polymethyl methacrylate, polystyrene and paraffin in a volume ratio of
(8-10):(9-11):(9-11):(7-9):(7-9):(43-48). Alternatively,
the organic binder contains stearic acid, polyethylene, polypropylene, polymethyl methacrylate, polystyrene and paraffin in a volume ratio of (10-12):(10-12):(10-12):(10-12):(10-12):(53-58). Alternatively,
the organic binder contains stearic acid, polyethylene, polypropylene, polymethyl methacrylate, polystyrene and paraffin in a volume ratio of (7.5-8.5):(7.5-8.5):(7.5-8.5):(7.5-8.5):(7.5-8.5):(40-42).

The organic binder contains stearic acid, paraffin, microcrystalline wax, ethylene-vinyl acetate copolymer and low-density polyethylene in a volume ratio of (4-6):(42-48):(12-17):(18-22):(22-28).

Where, the cemented carbide printed green body described in step (3) is prepared from the granular printing feedstock prepared in step (2) as a raw material by using an MEX device. The printing process involves using printing software of an AM system to slice and layer a 3D CAD model of a part, and importing the slice and layer data into the AM system; and after the granular printing feedstock is heated, according to the imported slice and layer data of the 3D CAD model of the part, the granular printing feedstock is extruded using a screw rod and printed layer by layer according to the slice data to obtain the printed green body.

Where, the green body printing technology described in step (3) is MEX, and the difficulty lies in minimizing or eliminating the printed defects (e.g., wedge-shaped or diamond-shaped pores and interlayer cracks) of a cemented carbide printed green body. After optimization, optional process parameters for the present disclosure for printing the cemented carbide green body include a nozzle diameter of 0.1 mm to 1.0 mm, a printing temperature of 100° C. to 220° C., a layer thickness of 0.08 mm to 0.5 mm, a printing speed of 10 mm/s to 80 mm/s, an extrusion flow rate of 50% to 100%, a microfilament overlap ratio of 0% to 60%, preferably 0% to 30%, a filling mode of one of [0, 90°] and [45°, −45°], or a combination of both, and a substrate temperature of 50° C. to 150° C. With the synergistic effect of the above parameters, the printed defects in the green body can be eliminated.

The microfilament overlap ratio described in the present disclosure is defined as the ratio of the overlap-width between two adjacent extruded feedstock microfilaments to the microfilament width which is the inner diameter of a nozzle.

Where, the difficulty of the solvent debinding process described in step (4) lies in designing a debinding process based on the composition and properties of the organic binder, to avoid swelling and cracking of the printed green body due to polymer components in the binder, while ensuring the debinding rate. The solvent debinding process designed in the present disclosure involves two-step solvent debinding with n-heptane, gasoline and/or kerosene: the cemented carbide green body prepared in step (3) is soaked in n-heptane for debinding for 4 h to 30 h; and then taken out and soaked in gasoline and/or kerosene for debinding for 1 h to 10 h; and finally dried in a vacuum drying box to obtain a solvent debound green body; Where, with a n-heptane debinding temperature of 5° C. to 50° C., preferably 20° C. to 35° C., a soaking time in the n-heptane of 4 h to 30 h, preferably 8 h to 20 h; a gasoline and/or kerosene debinding temperature of 10° C. to 55° C., preferably 20° C. to 40° C., a soaking time in the gasoline and/or kerosene of 1 h to 10 h, preferably 2 h to 6 h; a drying temperature of 40° C. to 80° C., preferably 40° C. to 60° C., and a drying time of 3 h to 14 h, preferably 6 h to 8 h. The design purpose of the two-step solvent debinding process is to control the debinding rate and prevent debinding defects such as bulges and cracking of the green body.

Or, a mixed solvent of n-heptane and gasoline and/or kerosene is used as a debinding solvent, with the purpose of controlling the debinding rate and preventing debinding defects such as bulges and cracking of the green body. An optional soaking extraction debinding time is typically 4 h to 60 h, and the specific debinding time may be adjusted according to an actual debinding conditions.

Where, the thermal debinding-sintering of the green body in step (5) is an integrated process of thermal debinding-vacuum pressure sintering. First step, thermal debinding of the green body: a sintering chamber is evacuated until the air pressure is less than 1000 Pa, and then the sintering chamber is filled with a reducing gas and heated from room temperature to a debinding temperature of 400° C. to 750° C. at a heating rate of 0.1° C./min to 3° C./min for carrying out debinding for 60 min to 120 min. Second step, vacuum pressure sintering: the sintering temperature is 750° C. to 1500° C., the sintering chamber is firstly evacuated until the air pressure is less than 1000 Pa, and then the sintering chamber is heated from the debinding temperature to a sintering temperature at a heating rate of 0.5° C./min to 10° C./min, and an inert gas is used for pressurization to 5 MPa to 10 MPa for carrying out sintering for 60 min to 180 min.

More preferably, in the first step, the heating rate for thermal debinding of the green body is 0.1° C./min to 1.5° C./min, and in the second step, the heating rate for vacuum pressure sintering is 0.5° C./min to 8° C./min. More preferably, in the first step, the heating rate is 0.3° C./min to 1.5° C./min, and in the second step, the heating rate is 1° C./min to 5° C./min.

The AM method for cemented carbides according to the present disclosure combines the polymer plasticizing component, and the framework component, and the dispersing component, and prepares the printing feedstock using the cemented carbide mixed powder as a raw material. The prepared printing feedstock shows high temperature stability and can be used for printing a green body over a wide temperature range. The plasticizing component designed in the organic binder can increase the powder loading of the printing feedstock. The printing process parameters are optimized to minimize the defects of pores and cracks of the printed cemented carbide green body. An appropriate debinding-sintering process designed based on the components of the organic binder can be used to prepare a solid cemented carbide part with a high relative density and excellent comprehensive mechanical properties.

### Advantages and Positive Effects of the Present Invention

(1) The AM method for cemented carbides according to the present disclosure can prepare a cemented carbide complex geometric structured product exhibiting excellent comprehensive mechanical properties. The prepared cemented carbide product is free of pores, cracks, and harmful phases such as decarburization phases, carbon defects and brittle phases, and has simple phase composition and a high relative density. Therefore, the present disclosure effectively overcomes the defects of cracking, pores, decarburization, brittle phases and deformation which are difficult to overcome by a present PBF AM process, as well as the defects of pores, deformation, low relative density, poor comprehensive mechanical properties and the like which make troubles in AM of cemented carbides for a long time and are difficult to overcome by a present green AM-debinding-sintering (GAM-DS) process. The present disclosure can employ a cemented carbide powder raw material used in a present powder metallurgical process and a ball milling process thereof. The prepared cemented carbide product has excellent hardness, transverse rupture strength and fracture toughness, and the preparation method is simple, low-cost and suitable for large-scale production.
(2) In the process of preparing the cemented carbide mixed powder by ball milling mixing raw powders, the paraffin is added to fully coat the powders, thereby preventing the powders from absorbing oxygen during the ball milling. The prepared cemented carbide powder has low oxygen content and uniform dispersion, which can be effectively eliminate oxidation and decarburization of the cemented carbide in the subsequent process.
(3) The framework component, the plasticizing component, and the dispersing component used in the organic binder of the present disclosure can reduce the requirements for the cemented carbide raw powders and facilitate debinding of the printed green body. Moreover, the raw materials are easily available, low-cost and thus suitable for industrial promotion and application.
(4) To solve the problem that a green body printed by a MEX process is prone to wedge-shaped or diamond-shaped pores, cracks and other defects, the present disclosure eliminates these wedge-shaped or diamond-shaped pores and cracks in the green body by the synergistic effect of the printing process parameters and the organic binder, and thus prepares the cemented carbide green body with a high relative density.
(5) The debinding process involving the two-step solvent debinding and thermal debinding designed by the present disclosure overcomes the debinding defects caused by the conventional too high solvent debinding speed. By combining the two-step solvent debinding with the thermal debinding using appropriate parameters, the debinding defects of a printed green body can be effectively eliminated, and the effective debinding rate can be improved. Further combination with a sintering process can eliminate sintering defects and harmful phases, and therefore, a sintering product has simple phase composition.
(6) The cemented carbide product prepared by the integrated process of thermal debinding-vacuum pressure sintering is nearly fully dense, and has low porosity, without metallurgical defects, cracks, and harmful phases such as decarburization phases, carbon defects and brittle phases. The quality and comprehensive mechanical properties of the product are superior to those of a present AM process and comparable to those of cemented carbides prepared by a powder metallurgical process.

The WC-9Co cemented carbide product prepared is a two-phase cemented carbide with no pores, no cracks and a uniform microstructure. After optimization, the prepared WC-9Co cemented carbide product has a relative density greater than 99.6%, and a Vickers hardness, a transverse rupture strength and a fracture toughness greater than or equal to 1522 HV30, 3447 MPa, and 19.92 MPa·m^{1/2}, respectively.

### BRIEF DESCRIPTION OF THE DRAWINGS

FIG. 1 shows an internal microstructure of a cemented carbide printed green body subjected to two-step solvent debinding in Example 1 of the present disclosure, with no debinding swelling, no debinding cracks;

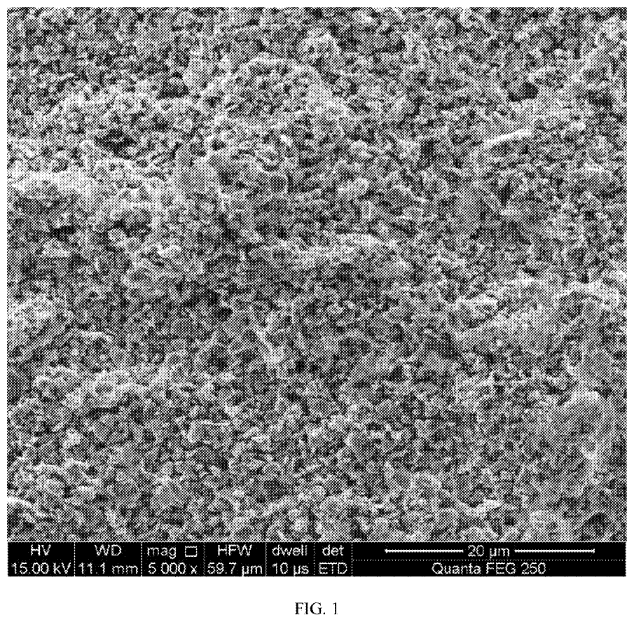

FIG. 2 shows an XRD phase analysis result of a sintered cemented carbide sample in Example 1 of the present disclosure, which is composed of WC and Co and contains no harmful phases such as uncombined carbon, decarburization phases, and ternary or multiple brittle phases;

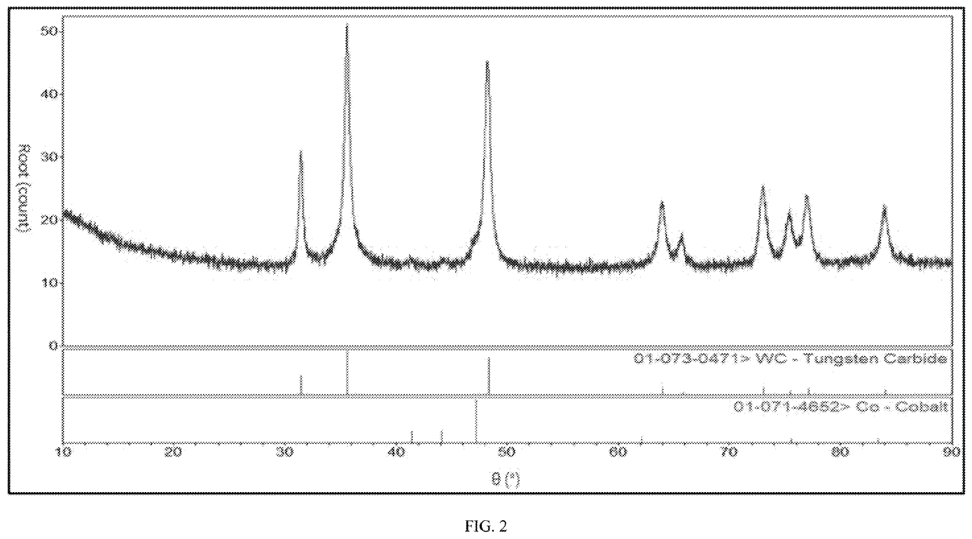

FIG. 3 shows an SEM microstructure of the sintered cemented carbide sample in Example 1 of the present disclosure, which contains no Co pool, uncombined carbon, decarburization phases, or brittle phases (before corrosion);

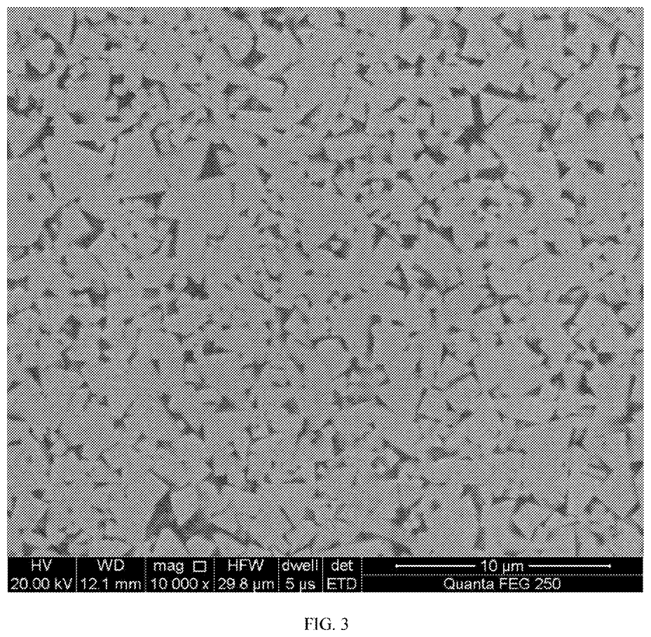

FIG. 4 shows a Micro-CT scan result of an internal structure of the sintered cemented carbide sample in Example 1 of the present disclosure, with no defects such as pores or cracks.

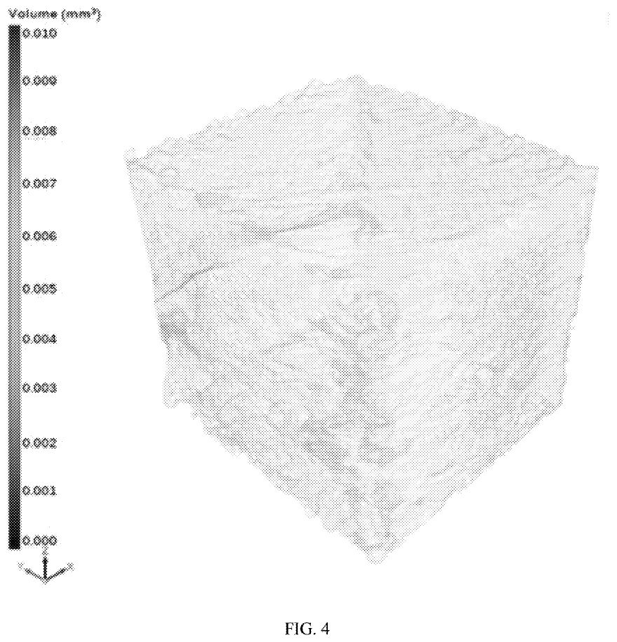

The following will further describe the present disclosure in detail with reference to specific examples. However, it is to be understood that these specific examples are merely used for illustration, but the present disclosure is not limited thereto. In addition, it is to be understood that after reading the content taught in the present disclosure, those skilled in the art can make various modifications and improvements to the present disclosure, and these equivalent forms shall also fall within the scope defined by the claims of the present application.

The AM method for cemented carbides according to the present disclosure combines AM with a powder metallurgical sintering process to prepare high-performance cemented carbide complex geometric structured products. The printing feedstock having a high powder loading and good printability can be prepared by using step (2) of the present disclosure. Wedge-shaped or diamond-shaped pores, cracks, and the like in the printed green body are eliminated by using the optimized process parameters in step (3) of the present disclosure. By the step (4) in the present disclosure, the solvent debinding defects, especially cracking, can be eliminated by the two-step solvent debinding of the printed green body. By the step (5) in the present disclosure, the integrated process of thermal debinding-vacuum pressure sintering, a cemented carbide product, which has a uniform microstructure, a high relative density (greater than 99.6% after optimization), excellent mechanical properties, and no metallurgical defects such as decarburization phases, carbon defects, brittle phases and cracks, can be prepared.

### DETAILED DESCRIPTION OF THE EMBODIMENTS

### Example 1

(1) Preparation of a WC—Co cemented carbide powder: WC (less than 5 μm in particle size) and Co powders were weighed according to a mass ratio of WC-9 wt. % Co, and paraffin accounting for 0.5% of the mass of the (WC-9 wt. % Co) was weighed. Anhydrous ethanol was used as a ball milling medium. Ball milling was carried out after adding in a tumbling ball mill for 60 h, followed by vacuum drying for 10 h and sieving to obtain a WC-9 wt. % Co cemented carbide mixed powder.
(2) Preparation of a printing feedstock: First, using an open-close internal mixer to preparate internal mixed mixture: The internal mixed mixture having a powder loading of 54 vol. % was prepared by internal mixing the raw materials of an organic binder composed of stearic acid, paraffin, microcrystalline wax, ethylene-vinyl acetate copolymer, and low-density polyethylene in a volume ratio of 5:45:15:20:25, as well as the WC-9 wt. % Co cemented carbide powder using an open-close internal mixer. Where, the rotation speed of the internal mixer was 30 r/min, the internal mixing temperature was 150° C., and the internal mixing time was 2 h. Then, using a granulator to prepare granular printing feedstock: Using the internally mixed mixture having a powder loading of 54 vol. % as a raw material, a granulator was used for granulation to prepare a granular printing feedstock having a particle size of 1.5 mm to 3.5 mm, where the temperatures of a heating chamber and a discharge port were 140° C. and 110° C. respectively, the rotation speed was 60 r/min, and the pressure of a screw rod was 10 kg.
(3) Preparation of a cemented carbide printed green body using MEX: Using the granular printing feedstock prepared in step (2) as a raw material, a cemented carbide printed green body was prepared using an MEX device. The printing parameters included a nozzle diameter of 0.4 mm, a printing temperature of 150° C., a layer thickness of 0.1 mm, a printing speed of 30 mm/s, a microfilament overlap ratio of 30%, an extrusion flow rate of 60%, a [0, 90°] MEX printing routing mode used, and a substrate temperature of 50° C. The relative density of the printed cemented carbide green body was about 98.4%.
(4) Solvent debinding: A two-step solvent debinding process of extraction debinding with n-heptane and extraction debinding with kerosene was used to subject the printed green body to solvent debinding. First, the printed green body was soaked in n-hexane for extraction debinding, the debinding time was 12 h, the debinding temperature was 30° C. Second, the green body that had been debound with the n-hexane was soaked in kerosene at 30° C. for extraction debinding for 1 h. The debinding solvents were both heated by in a water bath. Following solvent debinding, the green body was dried in a drying oven at a 45° C. for 5 h.
(5) Thermal debinding and sintering: Using a debinding-sintering integrated furnace, following solvent debinding, the green body was subjected to continuous thermal debinding and vacuum pressure sintering. First step, thermal debinding of the green body: A sintering chamber was evacuated until the air pressure was less than 100 Pa, and then filled with a reducing gas H₂ and heated from room temperature to a debinding temperature of 450° C., 550° C., 650° C. at a heating rate of 0.1° C./min to 3° C./min, heat preservation for 60 min using a gradient heating/heat preservation process; Second step, following thermal debinding, the debound green body was directly heated for vacuum-pressure sintering: First, the sintering chamber was evacuated until the air pressure was less than 100 Pa; and then heated from the debinding temperature of 650° C. to a sintering temperature of 1430° C. at a heating rate of 0.5° C./min to 10° C./min, and pressurized to 5 MPa with argon gas, the heat preservation time for sintering was 115 min; finally, obtained a sintered WC-9Co cemented carbide sample.

The sintered WC-9Co cemented carbide sample prepared by the above process had a relative density of 99.7%, a porosity of A02B00, carbon defects of C00, a η phase of E00, uniform dimensional shrinkage in all directions, and no cracks, warping or deformation. Among the prepared series of samples, the best detection indicators were a Vickers hardness of 1528 HV30, a transverse rupture strength of 3537 MPa, and a fracture toughness of 20.92 MPa·m^{1/2}.

### Example 2

The other parameters are consistent with Example 1, except that the microfilament overlap rate was 15% and the printing layer thickness was 0.1 mm. The relative density of the printed green body was about 98.1% to 98.2%.

According to step (4) and (5) of Example 1, Debinding and sintering were performed to obtain a sintered WC-9Co cemented carbide sample.

The sintered WC-9Co cemented carbide sample prepared by the above process had a relative density of 99.7%, a porosity of A02B00, carbon defects of C00, a η phase of E00, uniform dimensional shrinkage in all directions, and no cracks, warping or deformation. The mechanical properties were a Vickers hardness of 1525 HV30, a transverse rupture strength of 3488 MPa, and a fracture toughness of 20.33 MPa·m^{1/2}, respectively.

### Example 3

The other parameters are consistent with Example 1, except that the microfilament overlap rate was 30% and the printing layer thickness was 0.2 mm. The relative density of the printed green body was about 97.6% to 97.8%.

According to step (4) and (5) of Example 1, Debinding and sintering were performed to obtain a sintered WC-9Co cemented carbide sample.

The sintered WC-9Co cemented carbide sample prepared by the above process had a relative density of 99.69%, a porosity of A02B00, carbon defects of C00, a η phase of E00, uniform dimensional shrinkage in all directions, and no cracks, warping or deformation. The mechanical properties were a Vickers hardness of 1522 HV30, a transverse rupture strength of 3449 MPa, and a fracture toughness of 19.95 MPa·m^{1/2}, respectively.

As comparative examples, the followings are that the relative densities and mechanical properties of WC—Co cemented carbides reported in literature are prepared by powder metallurgy (PM), as well as green printing-debinding-sintering such as BJT-debinding-sintering-HIP, 3DGP-debinding-sintering, MEX-debinding-sintering, and other green printing-debinding-sintering processes and the like.

### Comparative Example 1

[1] J. Jiang, S. Ouyang, H. Chen, S. Guo, L. Yin, Z. Tan, H. Shi, Z. Zhong, L. Qiu, Effect of MWCNTs on microstructure and properties of WC-9Co gradient cemented carbides, Ceramics International, 48 (2022) 19295-19304

Jiang et al. [1] prepared a WC-9Co cemented carbide prepared by a powder metallurgical process of powder compacting, debinding and sintering, with a relative density of 99.57%, a Vickers hardness of 1227 HV20, a transverse rupture strength of 2519 MPa, and a fracture toughness of 12 MPa·m^{1/2} to 12.5 MPa·m^{1/2}, respectively, as shown in Table 1.

### Comparative Example 2

[2] M. Mariani, I. Goncharov, D. Mariani, G. P. De Gaudenzi, A. Popovich, N. Lecis, M. Vedani, Mechanical and microstructural characterization of WC—Co consolidated by binder jetting additive manufacturing, International Journal of Refractory Metals & Hard Materials, 100 (2021) 105639

Mariani et al. [2] prepared a WC-12Co cemented carbide prepared by a BJT-debinding-sintering-HIP process, with a relative density of 99.3%, a microhardness of 1205±12 HV10, and a transverse rupture strength of 2257±28 MPa, respectively, as shown in Table 1, and no fracture toughness data.

### Comparative Example 3

[3] T. Wolfe, R. Shah, K. Prough, J. L. Trasorras, Coarse cemented carbide produced via binder jetting 3D printing, International Journal of Refractory Metals and Hard Materials, 110 (2023) 106016

Wolfe et al. [3] prepared WC-10Co and WC-12Co cemented carbides prepared by the BJT-debinding-sintering-HIP process. The relative densities and mechanical properties of the cemented carbides are shown in Table 1. Where, the Vickers hardness, transverse rupture strength, and fracture toughness of the WC-10Co cemented carbide were 1119 HV30, 2231 MPa, and 18.8 MPa·m^{1/2}, respectively. The Vickers hardness, transverse rupture strength, and fracture toughness of the WC-12Co cemented carbide were 1050 HV30, 2684 MPa, and 19.4 MPa·m^{1/2}, respectively.

### Comparative Example 4

[4] X. Y. Zhang, Z. M. Guo, C. G. Chen, W. W. Yang, Additive manufacturing of WC-20Co components by 3D gel-printing, International Journal of Refractory Metals & Hard Materials, 70 (2018) 215-223

Zhang et al. [4] prepared a WC-20Co cemented carbide prepared by a 3DGP-debinding-sintering process, with a relative density of 99.9%, a hardness of 87.7 HRA, and a transverse rupture strength of 2612.8 MPa, respectively, as shown in Table 1, and no fracture toughness data.

### Comparative Example 5

[5] Z. Zhao, R. Liu, J. Chen, X. Xiong, Additive manufacturing of cemented carbide using analogous powder injection molding feedstock, International Journal of Refractory Metals and Hard Materials, 111 (2023) 106095

Zhao et al. [5] prepared a WC-8Co cemented carbide prepared by MEX-debinding-sintering, with a relative density of 99.3%, a Vickers hardness of 1350±20 HV30, a transverse rupture strength of 1695±30 MPa, and a fracture toughness of 7.27±0.5 MPa·m^{1/2} respectively, as shown in Table 1.

The present disclosure has significant advantages in relative density and comprehensive mechanical properties of the prepared WC—Co cemented carbides compared with that reported in the comparative examples prepared by the powder metallurgical process, BJT-debinding-sintering-HIP, 3DGP-debinding-sintering, and MEX-debinding-sintering and other green printing-debinding-sintering processes.

TABLE 1
Mechanical properties of WC-Co cemented carbides prepared by different processes

| | | Relative | | Transverse | Fracture | |
|---|---|---|---|---|---|---|
| Preparation | | density | Vickers | rupture | toughness | Data |
| process | Composition | (%) | hardness | strength (MPa) | (MPa · m^{1/2}) | source |
| Compression- | WC-9Co | 99.57 | 1227 | 2519 | 12 to 12.5 | [1] |
| debinding- | | | HV₂₀ | | | |
| sintering | | | | | | |
| BJT-debinding- | WC-12Co | 99.3 | 1205 ± 12 | 2257 ± 28 | — | [2] |
| sintering-HIP | | | HV₁₀ | | | |
| BJT -debinding- | WC-10Co | Full | 1119 | 2231 | 18.8 | [3] |
| sintering-HIP | | density | HV₃₀ | | | |
| BJT-debinding- | WC-12Co | Full | 1050 | 2684 | 19.4 | [3] |
| sintering-HIP | | density | HV₃₀ | | | |
| 3DGP- | WC-20Co | 99.9 | 87.7 | 2612.8 | — | [4] |
| debinding- | | | HRA | | | |
| sintering | | | | | | |
| MEX-debinding- | WC-8Co | 99.3 | 1350 ± 20 | 1695 ± 30 | 7.27 ± 0.5 | [5] |
| sintering | | | HV₃₀ | | | |

It is apparent that the foregoing examples and comparative examples are merely examples used for clear illustration, but the implementations are not limited thereto. For those of ordinary skill in the art, various modifications and improvements can also be made based on the above illustration. It is unnecessary and impossible to exhaustively list all implementations here. These apparent modifications and improvements derived there from shall fall within the protection scope of the present disclosure.

What is claimed is:

1. An additive manufacturing (AM) method for cemented carbides, comprising the following steps: (1) preparing a uniformly dispersed cemented carbide powder by ball milling; (2) preparing a cemented carbide printing feedstock by internal mixing; (3) preparing a cemented carbide printed green body using the cemented carbide printing feedstock; and (4) subjecting the cemented carbide printed green body to debinding-vacuum pressure sintering to obtain a cemented carbide product having excellent comprehensive mechanical properties.

2. The AM method for the cemented carbides according to claim 1, comprising the following steps:
(1) preparing the uniformly dispersed cemented carbide powder by ball milling:
mixing a hard raw powder with at least one of a binder metal raw powder Co and a binder metal raw powder Ni according to a first designed ratio, wherein the hard raw powder is WC; or the WC and at least one of TiC, Ti(C, N), (W, Ti)C, and (W, Ti, Ta)C; or the WC and at least one of VC, Cr₃C₂, TaC, and (Ta, Nb)C; or the WC, at least one of the TiC, the Ti(C, N), the (W, Ti)C, and the (W, Ti, Ta)C, and at least one of the VC, the Cr₃C₂, the TaC, and the (Ta, Nb)C; and
carrying out ball milling to prepare the uniformly dispersed cemented carbide powder;
(2) preparing the cemented carbide printing feedstock by internal mixing:
adding the uniformly dispersed cemented carbide powder and an organic binder into an internal mixing chamber of an internal mixer according to a second designed ratio and mixing the uniformly dispersed cemented carbide powder and the organic binder, to prepare a uniformly mixed mixture of the uniformly dispersed cemented carbide powder and the organic binder; and
adding the uniformly mixed mixture into a granulator and granulating the uniformly mixed mixture to prepare a granular printing feedstock having a particle size of 1 mm to 4 mm;
(3) preparing the cemented carbide printed green body by AM:
using the granular printing feedstock obtained in the step (2) as a raw material, and preparing the cemented carbide printed green body using a material extrusion device;
(4) subjecting the cemented carbide printed green body to solvent debinding: firstly, soaking the cemented carbide printed green body in n-heptane for debinding to obtain a first-treated green body, then soaking the first-treated green body in gasoline or kerosene for debinding to obtain a second-treated green body, and finally carrying out vacuum drying on the second-treated green body to obtain a solvent debound green body, wherein a soaking debinding time is determined according to a size of the cemented carbide printed green body, and a debinding temperature and a drying temperature and a drying time are determined according to characteristic temperatures of the organic binder and solvents; and
(5) thermal debinding-sintering: subjecting the solvent debound green body obtained in the step (4) to thermal debinding-vacuum pressure sintering to obtain a solid cemented carbide part, wherein a pressure is controlled to be greater than or equal to 5 MPa during the thermal debinding-vacuum pressure sintering.

3. The AM method for the cemented carbides according to claim 2, wherein the hard raw powder, the binder metal raw powder Co, and the binder metal raw powder Ni in the step (1) are powders meeting requirements for commercial powder metallurgical cemented carbides.

4. The AM method for the cemented carbides according to claim 2, wherein in the step (1), in addition to the hard raw powder, the binder metal raw powder Co, and the binder metal raw powder Ni as raw powders, paraffin is further added, with an amount of the paraffin added accounting for 0.5% to 5% of a total mass of the raw powders.

5. The AM method for the cemented carbides according to claim 2, wherein in the cemented carbide printing feedstock in the step (2), a volume proportion of the uniformly dispersed cemented carbide powder is 40% to 70%, and a volume proportion of the organic binder is 60% to 30%; and
internal mixing parameters in the step (2) comprise an internal mixing temperature of 100° C. to 200° C., a rotation speed of 30 rpm to 100 rpm, and an internal mixing time of 30 min to 300 min.

6. The AM method for the cemented carbides according to claim 2, wherein preparation parameters of the cemented carbide printing feedstock in the step (2) comprise a rotation speed of a screw rod of 30 rpm to 100 rpm and a pressure of the screw rod of 3 kg to 10 kg.

7. The AM method for the cemented carbides according to claim 2, wherein technological parameters for printing the cemented carbide printed green body in the step (3) comprise a nozzle diameter of 0.1 mm to 1.0 mm, a printing temperature of 100° C. to 220° C., a layer thickness of 0.08 mm to 0.5 mm, a printing speed of 10 mm/s to 80 mm/s, an extrusion flow rate of 50% to 100%, a microfilament overlap ratio of 0% to 60%, a filling mode of one of [0, 90°] and [45°, −45°], or a combination of [0, 90°] and [45°, −45°], and a substrate temperature of 50° C. to 150° C.

8. The AM method for the cemented carbides according to claim 2, wherein in the solvent debinding in the step (4), the cemented carbide printed green body prepared in the step (3) is soaked in the n-heptane for debinding for 4 h to 30 h to obtain the first-treated green body, then the first-treated green body is taken out and soaked in the gasoline and/or the kerosene for debinding for 1 h to 10 h to obtain the second-treated green body, and finally the second-treated green body is dried in a vacuum drying box to obtain the solvent debound green body, with a n-heptane debinding temperature of 5° C. to 50° C., a gasoline or kerosene debinding temperature of 10° C. to 55° C., the drying temperature of 40° C. to 80° C., and the drying time of 3 h to 14 h; or
a mixed solvent of the n-heptane and the gasoline and/or the kerosene is used for carrying out soaking and extraction debinding for 4 h to 60 h.

9. The AM method for the cemented carbides according to claim 2, wherein the thermal debinding-sintering of the solvent debound green body in the step (5) is an integrated process of thermal debinding-vacuum pressure sintering, comprising: first step, thermal debinding of the solvent debound green body: wherein a sintering chamber is evacuated until an air pressure is less than 1000 Pa, and the sintering chamber is filled with a reducing gas and heated from room temperature to a debinding temperature of 400° C. to 750° C. at a heating rate of 0.1° C./min to 3° C./min for carrying out debinding for 60 min to 120 min; and second step, vacuum pressure sintering: wherein a sintering temperature is 750° C. to 1500° C., the sintering chamber is evacuated until the air pressure is less than 1000 Pa, the sintering chamber is heated from the debinding temperature of 400° C. to 750° C. to the sintering temperature at a heating rate of 0.5° C./min to 10° C./min, and an inert gas is used for pressurization to 5 MPa to 10 MPa for carrying out sintering for 60 min to 180 min.

10. The AM method for the cemented carbides according to claim 1, wherein the cemented carbide product is a two-phase WC—Co cemented carbide with low porosity, no cracks, no decarburization, no brittle phases, and a uniform microstructure, or is a cemented carbide without harmful phases.

11. The AM method for the cemented carbides according to claim 7, wherein the microfilament overlap ratio is 0% to 30%.

12. The AM method for the cemented carbides according to claim 7, wherein the microfilament overlap ratio is 0% to 15%.

13. The AM method for the cemented carbides according to claim 8, wherein the n-heptane debinding temperature is 20° C. to 35° C.

14. The AM method for the cemented carbides according to claim 8, wherein a soaking time in the n-heptane is 8 h to 20 h.

15. The AM method for the cemented carbides according to claim 8, wherein the gasoline or kerosene debinding temperature is 20° C. to 40° C.

16. The AM method for the cemented carbides according to claim 8, wherein a soaking time in the gasoline or the kerosene is 2 h to 6 h.

17. The AM method for the cemented carbides according to claim 8, wherein the drying temperature is 40° C. to 60° C.

18. The AM method for the cemented carbides according to claim 8, wherein the drying time is 6 h to 8 h.

19. The AM method for the cemented carbides according to claim 2, wherein the cemented carbide product is a two-phase WC—Co cemented carbide with low porosity, no cracks, no decarburization, no brittle phases, and a uniform microstructure, or is a cemented carbide without harmful phases.
